(19) United States
(12) Patent Application Publication
(10) Pub. No.: US 2023/0009879 A1
(43) Pub. Date: Jan. 12, 2023

(54) GOLF BAG MOUNTING SYSTEM FOR A STANDUP MOTORIZED TRANSPORT UTILITY VEHICLE

(71) Applicant: LyteHorse Labs, Inc., Regina (CA)

(72) Inventors: Allen William BONK, Regina (CA); Bradley James BONK, Regina (CA)

(21) Appl. No.: 17/810,903

(22) Filed: Jul. 6, 2022

Related U.S. Application Data
(60) Provisional application No. 63/218,946, filed on Jul. 7, 2021.

(51) Int. Cl. B60R 9/08; B60R 9/02

(52) U.S. Cl. CPC B60R 9/08; B60R 9/02

(57) ABSTRACT

A motorized standup utility vehicle having a golf bag mounting system to mount a golf bag. The golf bag mounting system enables the golf bag to swivel in multiple positions (left, right, center) and rotate and tilt between a range of 90 degrees (vertical) to 30 degrees (horizontal) positions. The golf bag mounting system comprises an upper bag support assembly, a lower bag support assembly, a swivel mounting plate, a cradle bracket, a bushing plate and a cylindrical tube which are all connected by connecting bolts. Further bungee cords are used to secure a golf bag to the golf bag mounting system.

### CROSS REFERENCE TO RELATED APPLICATIONS

The application claims priority to and the benefit of US Utility Provisional Application Ser. No. 63/218,946, entitled “GOLF BAG MOUNTING SYSTEM FOR A STANDUP MOTORIZED TRANSPORT UTILITY VEHICLE”, filed on Jul. 7, 2021, which is incorporated herein by reference in its entirety.

### BACKGROUND

The embodiments described herein relate to motorized vehicles, and more particularly to a single-rider, standup electric utility vehicle.

Conventional motorized golf carts with parallel wheels and axles are used to haul golf bags and golf carts. Mounted golf bags have traditionally been mounted in a vertical position on golf carts making it slow and sometimes difficult to find the desired club. Having to pull out the selected club is more awkward than it needs to be.

A new generation of motorized standup vehicles such as the vehicle described in U.S. Utility patent application Ser. No. 17/076,754, entitled “SYSTEM AND METHOD FOR A STANDUP MOTORIZED TRANSPORT UTILITY VEHICLE”, filed on Oct. 21, 2020, which is incorporated herein by reference in its entirety, is designed for multi-functional use including usage on golf courses and for hauling golf bags.

Accordingly, there is a desire to implement a golf bag mount design on a motorized vehicle for easy access to golf bags and golf clubs.

### SUMMARY

A motorized standup utility vehicle having a golf bag mounting system to mount a golf bag. The golf bag mounting system enables the golf bag to swivel to multiple positions (left, right, center) and rotate and tilt between a range of 90 degrees (vertical) to 30 degrees (horizontal) positions. The golf bag mounting system comprises an upper bag support assembly, a lower bag support assembly, a swivel mounting plate, a cradle bracket, a bushing plate and a cylindrical tube which are all connected by connecting bolts. Further bungee cords may be used to secure a golf bag to the golf bag mounting system.

### BRIEF DESCRIPTION OF THE DRAWINGS

FIG. 1 is a line drawing of a perspective view of a standup motorized utility vehicle in accordance with certain embodiments of this disclosure.

FIGS. 2A-2D are diagrams illustrating various views of a utility vehicle with a golf bag mounting system.

FIGS. 3A-3D are diagrams illustrating various views of a utility vehicle with a golf bag installed on a golf bag mounting system.

FIG. 4A is a line drawing of a side view of a golf bag mounting system.

FIG. 4B is a line drawing of a rear view of a golf bag mounting system.

FIG. 4C is a line drawing of a top view of a golf bag mounting system.

FIG. 4D is a close-up view of the golf bag mounting system swivel.

FIG. 5 is a line drawing of an exploded view of a golf bag mounting system.

FIG. 6 is a diagram of different components of a golf bag mounting system.

### DETAILED DESCRIPTION

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purpose of illustration rather than to limit the present invention. The invention is to cover all modifications, equivalents, and alternatives falling within the scope of the invention as defined by the appended claims.

The various features or aspects discussed herein can also be combined in additional combinations and embodiments, whether or not explicitly discussed herein, without departing from the scope of the invention.

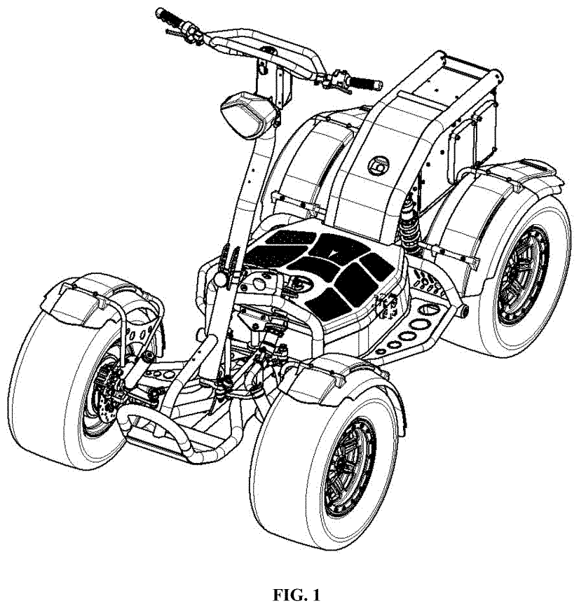

FIG. 1 is a line drawing of a perspective view of a standup motorized utility vehicle in accordance with certain embodiments of this disclosure. According to FIG. 1, the utility vehicle is configured for a single rider to drive the vehicle while in a standing position. More information on a utility vehicle can be further described in U.S. Utility patent application Ser. No. 17/076,754, entitled “SYSTEM AND METHOD FOR A STANDUP MOTORIZED TRANSPORT UTILITY VEHICLE”, filed on Oct. 21, 2020 and U.S. Utility patent application Ser. No. 17/659,560, entitled “A SEAT POST ASSEMBLY FOR A STANDUP MOTORIZED TRANSPORT UTILITY VEHICLE”, filed on Apr. 18, 2022 both of which are incorporated herein by reference in its entirety.

According to FIG. 1, the dimensions of the utility vehicle include a length of 91⅛ inches, a height of 58 inches, a front wheel width of 47⅝ inches and a rear wheel width of 34 13/16 inches. Of note is a wider front wheel width compared to the rear wheel width to provide better stability and maneuverability. Other embodiments may have different dimensions.

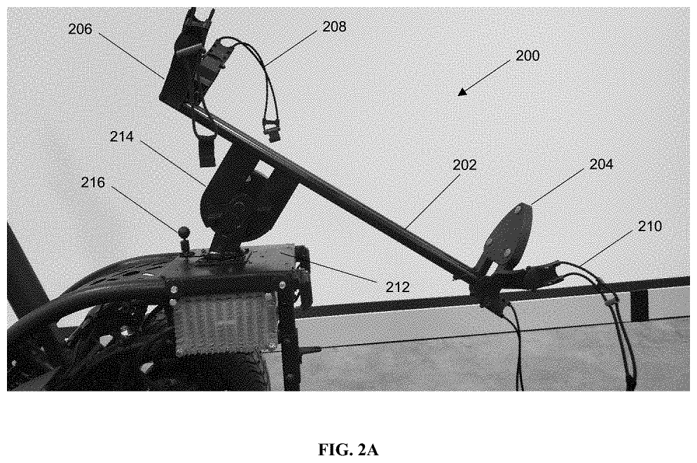

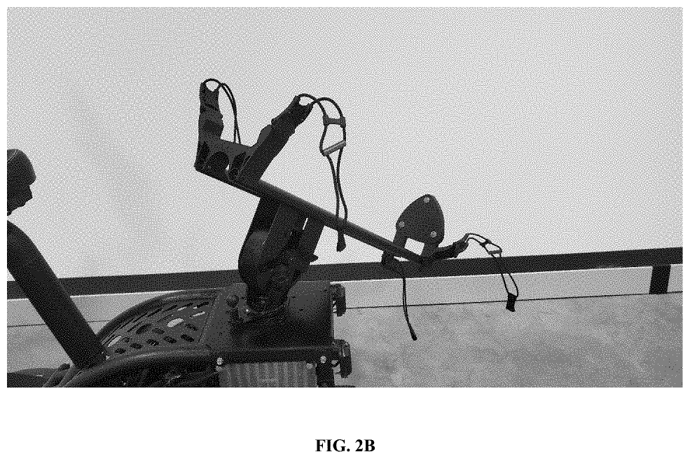

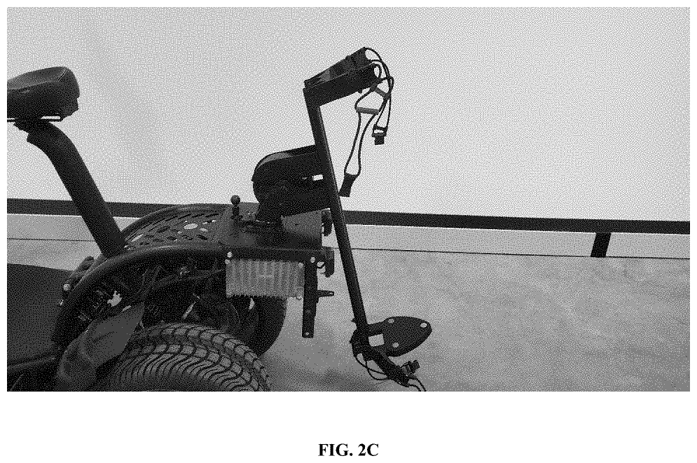

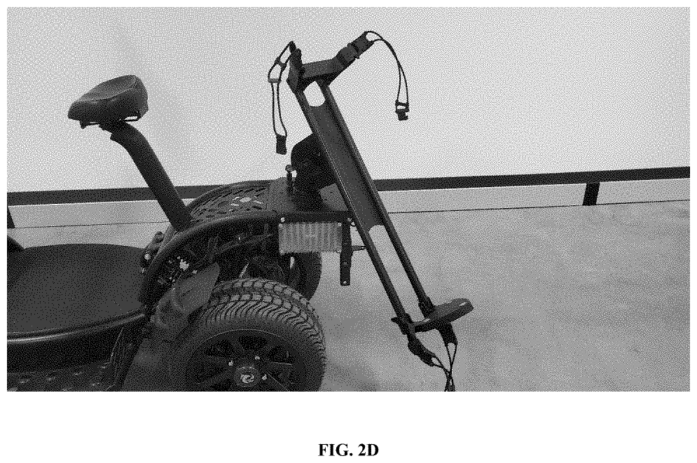

FIGS. 2A-2D are diagrams illustrating various views of a utility vehicle with a golf bag mounting system. FIG. 2A is a left side view of a golf bag mounting system on a utility vehicle, preferably a standup motorized vehicle. According to FIG. 2A, golf bag mounting system 200 consists of a frame 202, a base or bottom mount 204 and a top mount 206. Base or bottom mount 204 is attached to bottom strap 210 and top mount 206 is attached to top straps 208. Top straps 208 and bottom straps 210 are configured to secure a golf bag in place on the utility vehicle, by securely coupling (or connecting) to the golf bag, by retaining the golf bag in place through elastic or frictional forces, or through some other means.

According to FIG. 2A, golf bag mounting system 200 is attached to the utility vehicle at horizontal base plate 212 and pivot mount 214 to frame 202. Pivot mount 214 allows golf bag mounting system 200 to move freely in 270 degrees in the vertical plane (i.e., y-direction) and horizontal plane (i.e., z-direction). Pivot mount 214 also includes a pivot mount hand lock 216 that enables the user to pivot mount 214 and lock securely in the horizontal plane (i.e., z-direction).

FIG. 2B is a further left side view of a golf bag mounting system on a utility vehicle that is pivoted at a 30 degrees angle on the horizontal plane (i.e., flat plane or z-direction). FIG. 2C is a further left side view of a golf bag mounting system on a utility vehicle that is pivoted at a 90 degrees angle on the vertical plane (i.e., y-direction). FIG. 2D is a further left side view of a golf bag mounting system on a utility vehicle that is pivoted at a 90 degrees angle on the vertical plane (i.e., y-direction) and 270 degrees angle on the horizontal plane (i.e., z-direction).

According to FIG. 2A, frame 202 is designed to accommodate one golf bag, however alternate frame designs can be configured to hold two or more bags with a larger frame and longer straps (208, 210) or multiple straps. According to further embodiments, the golf bag mounting system can be retrofitted to house other objects other than golf bags including fishing poles, skis, hunting rifles, sporting equipment or large duffle bags.

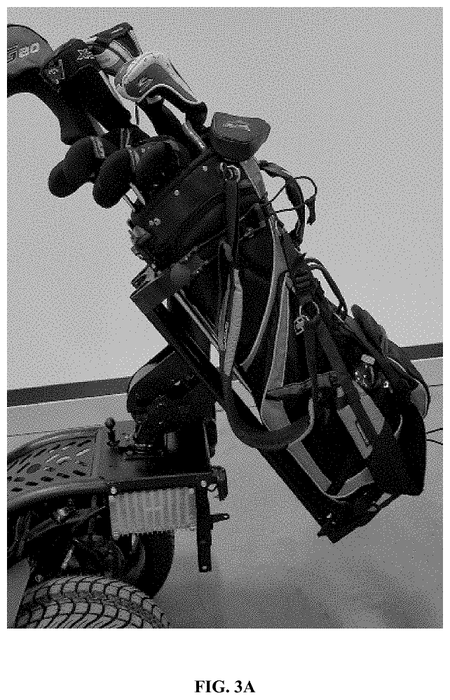

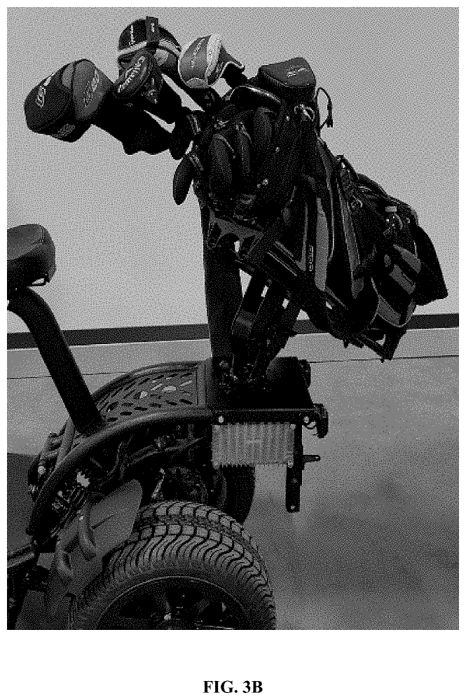

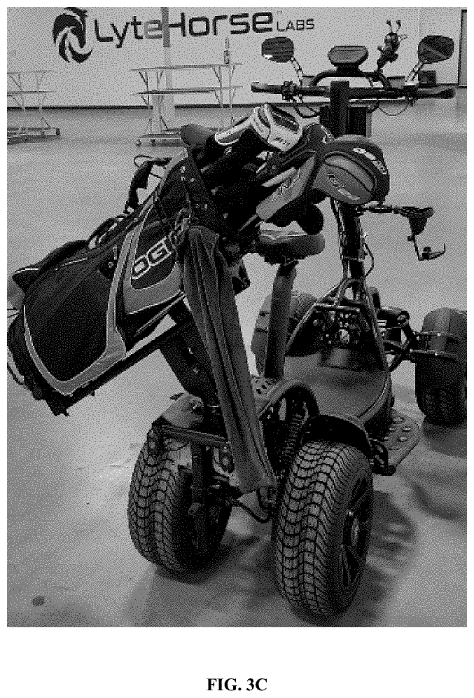

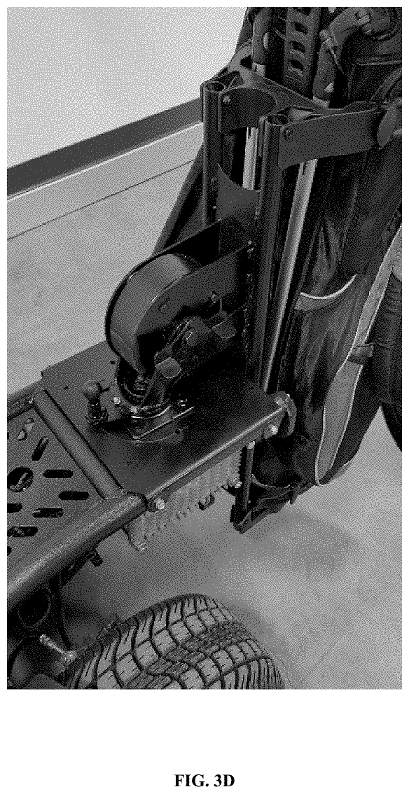

FIGS. 3A-3D are diagrams illustrating various views of a utility vehicle with a golf bag installed on a golf bag mounting system. FIG. 3A is a left side view of a golf bag mounting system on a utility vehicle mounted with a golf bag with golf clubs. FIG. 3B is a further left side view of a golf bag mounting system on a utility vehicle mounted with a golf bag with golf clubs that is pivoted at a 30 degrees angle on the horizontal plane (i.e., flat plane or z-direction). FIG. 3C is a rear perspective view of a golf bag mounting system on a utility vehicle mounted with a golf bag with golf clubs. FIG. 3D is a close-up view of a golf bag mounting system on a utility vehicle mounted with a golf bag with golf clubs wherein the golf bag mounting system is pivoted at a 90 degrees angle on the vertical plane (i.e., y-direction).

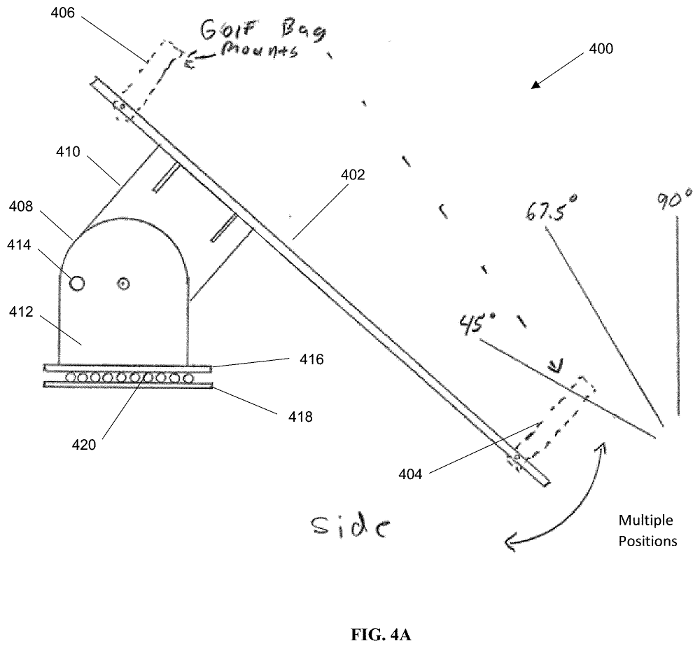

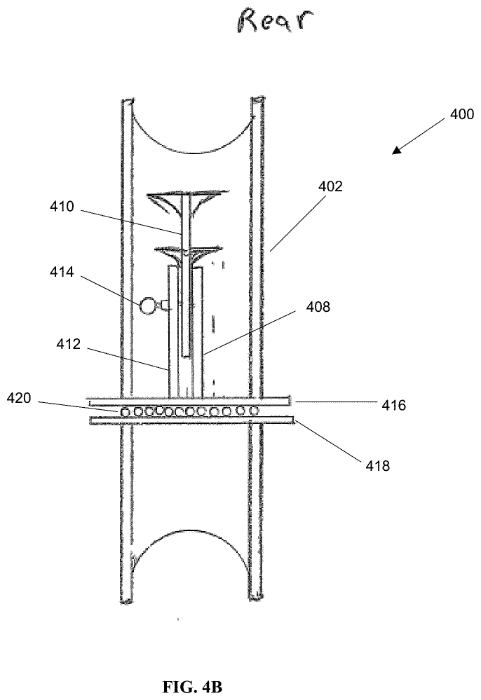

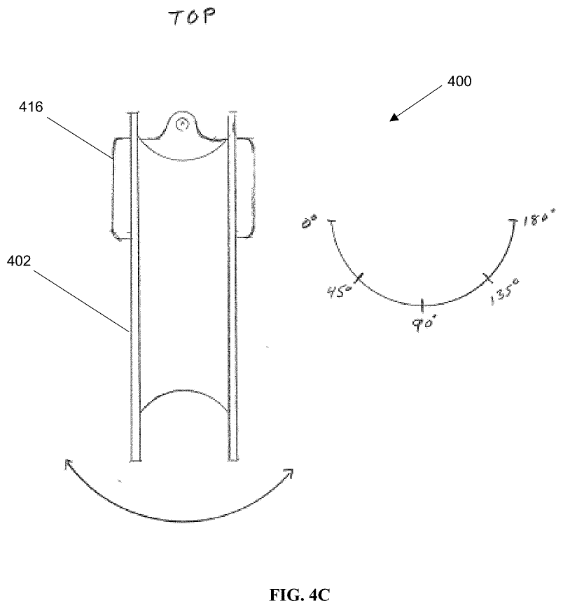

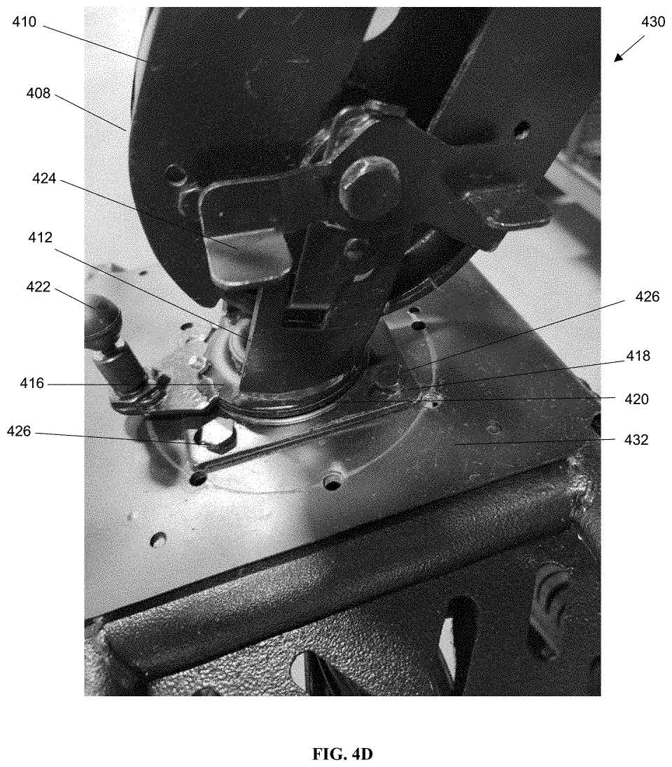

FIG. 4A is a line drawing of a side view of an embodiment of a golf bag mounting system. According to FIG. 4A, golf bag mounting system 400 consists of a frame 402, a base or bottom mount 404 and a top mount 406. Pivot mount 408 consists of a substantially semi-circular bottom portion 412, handle lock 414, pivot mount base 416 and an upper portion 410 wherein the upper portion 410 is connected to the frame 402. Golf bag mounting system 400 is attached to a utility vehicle at horizontal base plate 418 which connects moveably to the pivot mount base 416 of the pivot mount 408. Pivot mount base 416 sits on top of an abrasion-resistant layer, such as a layer of ball bearings 420 (i.e., ball bearings 420 are sandwiched between pivot mount base 416 and horizontal base plate 418). Ball bearings 420 enable the pivot mount 408 to swivel left and right freely in the z-direction, through the rotation of pivot mount base 416 relative to horizontal base plate 418.

According to FIG. 4A, pivot mount 408 allows golf bag mounting system 400 to move freely in 360 degrees in the vertical plane (i.e., y-direction) and horizontal plane (i.e., z-direction). Pivot mount 408 swivels in the vertical plane up and down (i.e., y-direction) by moving the upper portion 410 at different angles where it can lock into place at pre-configured angle ranges (e.g., 45 degrees, 67.5 degrees and 90 degrees) using the handle lock 414. Pivot mount 408 swivels in the horizontal plane by turning the bottom portion 412 left and right (i.e., z-direction). In another embodiment, the abrasion-resistant layer may be a plastic bushing, or some other layer which can provide similar rotational slippage between pivot mount base 416 and horizontal base plate 418.

FIG. 4B is a line drawing of a rear view of a golf bag mounting system. According to FIG. 4B, golf bag mounting system 400 is shown in a rear view having a frame 402 connected to pivot mount 408. Pivot mount 408 consists of bottom portion 412, handle lock 414, pivot mount base 416 and an upper portion 410 wherein the upper portion 410 is connected to the frame 402 and the bottom portion 412 is connected to pivot mount base 416 which is then securely connected to the utility vehicle at horizontal base plate 418. Sandwiched between pivot mount base 416 and horizontal base plate 418 is an abrasion-resistant layer, such as a layer of ball bearings 420. In another embodiment, the abrasion-resistant layer may be a plastic bushing, or some other layer that can provide similar rotational slippage between pivot mount base 416 and horizontal base plate 418.

According to FIG. 4B, bottom portion 412 is substantially rectangular in profile view (i.e., side view) and has a slot to feed top portion 410 therebetween. Handle lock 414 consists of a handle and a pin that pierces through holes of top portion 410 to lock pivot mount 408 in place at different pre-configured angles. Frame 402 is substantially concave in shape to securely house a golf bag.

FIG. 4C is a line drawing of a top view of a golf bag mounting system. According to FIG. 4C, golf bag mounting system 400 is shown in a top view having a frame 402 that is substantially concave in shape and a pivot mount base 416. Pivot mount base 416 enables pivot mount to pivot left and right in a range of angle from 0 degrees to 180 degrees with pre-configured 45 degree lock points (e.g., stops at 0 degrees, 45 degrees, 90 degrees, 135 degrees and 180 degrees).

According to embodiments of this disclosure, the golf bag mounting system positions the golf bag in a cradle that is then able to tilt from 90 degrees vertical to 30 degrees horizontal and anywhere in between allowing the user to set their desired position and lock it in. A closer view of the golf bag mounting system pivot mechanism is further shown in FIG. 4D.

According to FIG. 4D, there is also a swivel system 430 built in with 5 pre-set locking positions that allows the system to swivel left, right and center positions. This allows the golfer to choose which side they will draw their clubs from. If a rider (user) steps off the motorized utility vehicle on the right, the golf clubs may then be facing them and likewise on the left. Club selection has never been easier as they are all in full view.

According to FIG. 4D, swivel system 430 consists of pivot mount 408 having an upper mount portion 410 and lower mount portion 412, pivot mount base 416 and ball lock handle 422. Pivot mount 408 also consists of swivel handle 424 so the user can grasp and pivot the upper mount portion 410. Ball lock handle 422 enables user to swivel the pivot mount base 416 around horizontal base plate 418 of the utility vehicle and lock it in place at one of the multiple locking holes. Ball lock handle 422 also contains a spring locking pin. Horizontal base plate 418 is securely mounted to the body of the utility vehicle 432 by multiple large bolts 426. According to FIG. 4D, four large bolts 426 are used. According to further embodiments, outer securing mechanisms such as screws, glue, Velcro, nails can be used as a securing mechanism to replace large bolts 426. Sandwiched between pivot mount base 416 and horizontal base plate 418 is an abrasion-resistant layer, such as a layer of ball bearings 420. In another embodiment, the abrasion-resistant layer may be a plastic bushing, or some other layer that can provide similar rotational slippage between pivot mount base 416 and horizontal base plate 418.

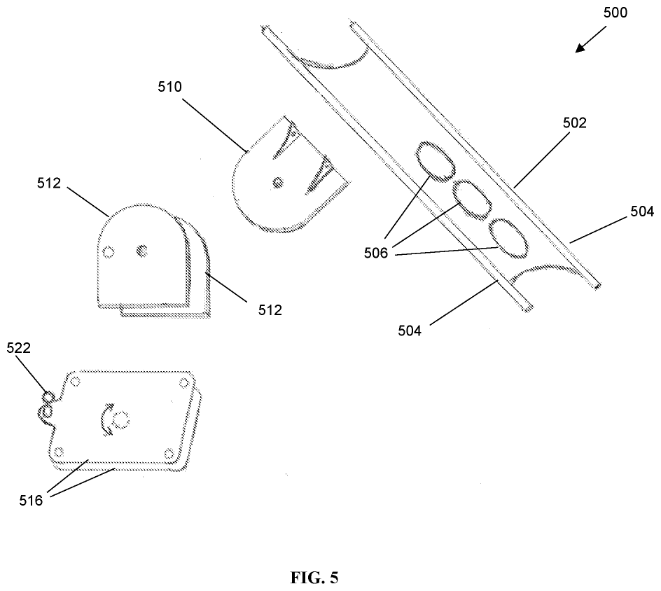

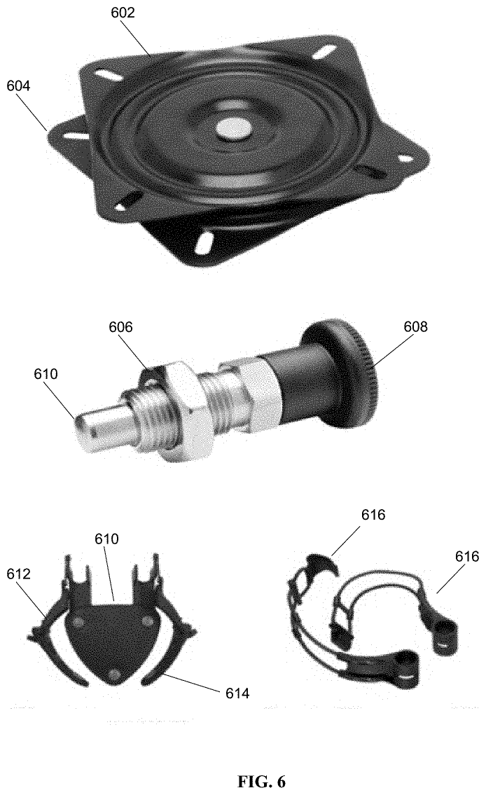

FIG. 5 is a line drawing of an exploded view of an embodiment of the golf bag mounting system. FIG. 6 is a diagram of different components of a golf bag mounting system. According to FIGS. 5 and 6, the golf bag mounting system 500 comprises frame 502, pivot mount top portion 510, pivot mount bottom portion 512 and pivot mount base plates 516. According to FIG. 5, frame 502 is made of metal and has a length of 34 inches and a width of 4 inches and a concave body. Frame 502 also contains a tubular edge 504 further comprising a 1 inch tube. Frame 506 further comprises a plurality of holes 506 punched through the frame that makes frame 502 lighter and providing a window to see other parts of the golf bag mounting system therethrough. Other embodiments may have different dimensions.

According to FIG. 5, golf bag mounting system 500 also contains a pivot mount top portion 510 (also referred to as a bushing plate) that is substantially semi-circular in shape with a center hole to receive a pin and pre-configured pivot holes around the edge for locking the system in place. Golf bag mounting system 500 also contains two pivot mount bottom portion plates 512 with a central hole that aligns with central hole of pivot mount top portion 510 with a radius of 4.5 inches.

According to FIG. 5, golf bag mounting system 500 also contains a lower base portion comprising two pivot mount base plates 516 that can swivel around a central pivot. The two pivot mount base plates 516 have dimensions of 6.5 inches length and 6.5 inches width, and this assembly additionally comprises a ball handle locking pin 522. In another embodiment, the pivot mount base plates 516 may have other dimensions.

Another embodiment of the pivot mount plates 602 and 604 is also shown in FIG. 6 and is made of metal. In this embodiment, pivot mount plates 602 and 604 may be separated by a plastic bushing, ball bearings, or some other separator which may allow the plates to rotate with respect to one another.

According to FIGS. 5 and 6, ball handle locking pin 522 also consists of ball handle 608, bolt 606 and spring locking pin 610. Spring locking pin 610 can move when force is applied and is configured to lock in place into one of the pre-configured holes of the swivel horizontal base plate 418 of the utility vehicle as shown in FIG. 4D.

According to FIG. 6, golf bag mounting system 500 also consists of a lower bag support assembly 610 comprising a frame base 612 having legs 614 and 616. According to FIG. 6, golf bag mounting system 500 also consists of lower wrap assembly 620 having bungee straps 622 and 624 that are secured in place to lower bag support assembly 610 and secures a golf bag when connected.

While a primary use of the golf bag mount is to hold a golf bag, it may be directly used or adapted for uses such as carrying a rifle bag, a gun bag, a tool bag or chest, or other container. In further embodiments, the golf bag mount can be configured to carry fishing rods, sporting equipment (e.g., skis, snowboards, hockey sticks, etc.). In further embodiments, the golf bag mount can also be configured to work with hoists (for lifting and towing) and outriggers. According to further embodiments, in addition to utility vehicles, the golf bag mount can be equipped on other types of machinery, such as snowmobiles, bicycles, motorcycles, boats and airplanes.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A golf bag mounting system for use in a motorized utility vehicle, comprising:
a frame having a base mount and a top mount;
a top strap and bottom strap attached to the base mount and top mount respectively configured to secure a golf bag in place on the utility vehicle;
a horizontal base plate of the utility vehicle;
a pivot mount connected to the frame and the horizontal base plate, the pivot mount further comprising:
a top portion (bushing plate) that is substantially semi-circular in shape at one end and connects to the frame;
a pivot mount base that is planar (in same plane) as the horizontal base plate of the utility vehicle; and
a handle lock on the top portion and/or pivot mount base;
wherein the pivot mount is configured to move freely in the vertical plane (i.e., y-direction) and horizontal plane (i.e., z-direction);
wherein the handle lock enables the system and lock securely in the horizontal plane (i.e., z-direction) or the vertical plane (i.e., y-direction).

2. The golf bag mounting system of claim 1, wherein the mounting system is substantially made of metal.

3. The golf bag mounting system of claim 1, wherein the straps are flexible bungee cords.

4. The golf bag mounting system of claim 1, wherein the mounting system's range of movement in the y-direction is 0 degrees to 270 degrees.

5. The golf bag mounting system of claim 1, wherein the range of movement in z-direction is 0 degrees to 180 degrees.

6. The golf bag mounting system of claim 1, further comprising a layer of ball bearings between the base pivot plate and horizontal base plate, which layer of ball bearings enables swivelling.

7. The golf bag mounting system of claim 1, further comprising large bolts on the horizontal base plate to secure it in place onto the body of the utility vehicle.

8. The golf bag mounting system of claim 1, further comprising a spring-loaded handle lock, the spring-loaded handle lock further comprising a ball handle, bolt and spring-loaded push pin.

9. A motorized utility vehicle enabled for operation by a standing rider and configured to support a glove bag mount system, the vehicle comprising:
a vehicle frame;
a motor housed within the frame;
two front powered wheels connected to the frame;
two rear powered wheels connected to the frame;
a steering column connected to the frame;
a handlebar connected to the distal end of the steering column; and
a seat post assembly configured to support the rider in a standing position and a sitting position; and
a golf bag mounting system further comprising:
a frame having a base mount and a top mount;
a top strap and bottom strap attached to the base mount and top mount respectively configured to secure a golf bag in place on the utility vehicle;
a horizontal base plate, which base plate is securely fastened to the utility vehicle;
a pivot mount connected to the frame and the horizontal base plate, the pivot mount further comprising:
a top portion (bushing plate) that is substantially semi-circular in shape at one end and connects to the frame;
a pivot mount base that is planar (in same plane) as the horizontal base plate of the utility vehicle; and
a handle lock on the top portion and/or pivot mount base;
wherein the pivot mount is configured to move freely in the vertical plane (i.e., y-direction) and horizontal plane (i.e., z-direction);
wherein the handle lock enables the system and lock securely in the horizontal plane (i.e., z-direction) or the vertical plane (i.e., y-direction).

10. The golf bag mounting system of claim 9, wherein the mounting system is substantially made of metal.

11. The golf bag mounting system of claim 9, wherein the straps are flexible bungee cords.

12. The golf bag mounting system of claim 9, wherein the mounting system's range of movement in the y-direction is 0 degrees to 270 degrees.

13. The golf bag mounting system of claim 9, wherein the range of movement in z-direction is 0 degrees to 180 degrees.

14. The golf bag mounting system of claim 9, further comprising a layer of ball bearings between the base pivot plate and horizontal base plate, which layer of ball bearings enables swivelling.

15. The golf bag mounting system of claim 9, further comprising large bolts on the horizontal base plate to secure it in place onto the body of the utility vehicle.

16. The golf bag mounting system of claim 9, further comprising a spring-loaded handle lock, the spring-loaded handle lock further comprising a ball handle, bolt and spring-loaded push pin.

17. A golf bag mounting system for use in a motorized utility vehicle, comprising a pivot base mount, a horizontal base plate connected rotatably to the pivot base mount, and an abrasion-resistant layer located between the pivot base mount and the horizontal base plate.
